(19) United States
(12) Patent Application Publication
(10) Pub. No.: US 2024/0193171 A1
(43) Pub. Date: Jun. 13, 2024

(54) ASSISTANCE SYSTEM, ASSISTANCE METHOD, AND RECORDING MEDIUM FOR ASSISTING IN IDENTIFYING TOPIC IN CONVERSATION BETWEEN CUSTOMER AND OPERATOR

(71) Applicant: NEC Corporation, Tokyo (JP)

(72) Inventor: Yuri KAWAMOTO, Tokyo (JP)

(73) Assignee: NEC Corporation, Tokyo (JP)

(21) Appl. No.: 18/531,021

(22) Filed: Dec. 6, 2023

(30) Foreign Application Priority Data
Dec. 12, 2022 (JP) 2022-197579

(51) Int. Cl. G06F 16/248; G06F 16/2455; G06F 40/35; G06Q 30/015

(52) U.S. Cl. CPC G06F 16/248; G06F 16/2455; G06F 40/35; G06Q 30/015

(57) ABSTRACT

An assistance system includes: a memory storing instructions; and one or more processors configured to execute the instructions to: acquire conversation data of a conversation between a customer and an operator; extract, from the conversation data, a characteristic of a store clerk who is a topic of the conversation; search for a store clerk having a characteristic corresponding to the extracted characteristic of the store clerk from among store clerks who work at a store; and cause a display device to display information regarding the searched store clerk.

This application is based upon and claims the benefit of priority from Japanese Patent Application No. 2022-197579, filed on Dec. 12, 2022, the disclosure of which is incorporated herein in its entirety by reference.

### TECHNICAL FIELD

The present disclosure relates to an assistance system and the like.

### BACKGROUND ART

In a customer support center, an operator receives various inquiries from customers. For example, the operator answers an inquiry about a product or a service and responds to a complaint.

Japanese Patent Application Laid-open Publication No. 2022-066489 discloses a search result display device that automatically displays an answer to a requirement of a customer. In this publication, a keyword extracted from an utterance of the customer about the requirement or from an utterance of a person responding to the customer about checking for the requirement is used as a search query. Then, a search result of a searched document is displayed.

Japanese Patent Application Laid-open Publication No. 2007-226509 discloses a complaint handling auxiliary device that clarifies a person in charge of handling a complaint. In this publication, a keyword defined in advance is extracted from the complaint. Then, the person in charge is extracted based on the extracted keyword.

### SUMMARY

An example of an object of the present disclosure is to provide an assistance system and the like that facilitate identification of a conversation topic from ambiguous information provided by a customer.

An assistance system according to an aspect of the present disclosure includes acquiring means that acquires conversation data of a conversation between a customer and an operator, extracting means that extracts, from the conversation data, a characteristic of a store clerk who is a topic of the conversation, searching means that searches for a store clerk having a characteristic corresponding to the extracted characteristic of the store clerk from among store clerks who work at a store, and display control means that causes a display device to display information regarding the searched store clerk.

An assistance method according to an aspect of the present disclosure includes acquiring conversation data of a conversation between a customer and an operator, extracting a characteristic of a store clerk who is a topic of the conversation from the conversation data, searching for a store clerk having a characteristic corresponding to the extracted characteristic of the store clerk from among store clerks who work at a store, and causing a display device to display information regarding the searched store clerk.

A computer-readable recording medium according to an aspect of the present disclosure non-temporarily stores a program for causing a computer to execute processing of acquiring conversation data of a conversation between a customer and an operator, extracting a characteristic of a store clerk who is a topic of the conversation from the conversation data, searching for a store clerk having a characteristic corresponding to the extracted characteristic of the store clerk from among store clerks who work at a store, and causing a display device to display information regarding the searched store clerk.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a scene where a customer makes an inquiry:

FIG. 2 is a block diagram illustrating an example of a configuration of an assistance system:

FIG. 3 is an example of information regarding a store clerk stored in a database:

FIG. 4 is a diagram illustrating an example of a screen displayed to an operator:

FIG. 5 is a flowchart illustrating an example of an operation of the assistance system:

FIG. 6 is a flowchart illustrating another example of the operation of the assistance system; and

FIG. 7 is a block diagram illustrating an example of a hardware configuration of a computer.

### EXAMPLE EMBODIMENT

### First Example Embodiment

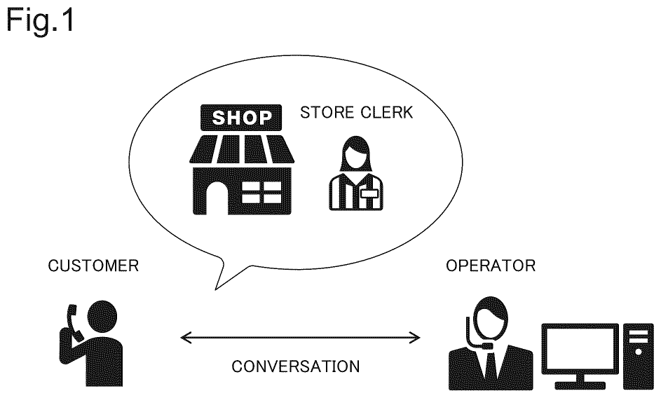

In one example embodiment, it is assumed that a customer who used a store makes an inquiry about a service or a product of the store to a customer support center. In the following description, the customer support center is described as a customer center. FIG. 1 is a diagram illustrating a scene where the customer makes an inquiry. As illustrated in FIG. 1, the customer has a conversation with an operator. The operator is a person in charge who responds to an inquiry from a customer at the customer center. The conversation may be performed by voice or by text. The operator may be, for example, a conversation robot such as a chatbot. In a conversation with the operator, a store clerk who a customer finds in the store may become a topic. An assistance system 100 that assists in identifying a store clerk who is a conversation topic will be described below. The number of stores for which inquiries are to be received by the customer center is not particularly limited. In the following description, it is assumed that the customer center receives inquiries about a plurality of stores.

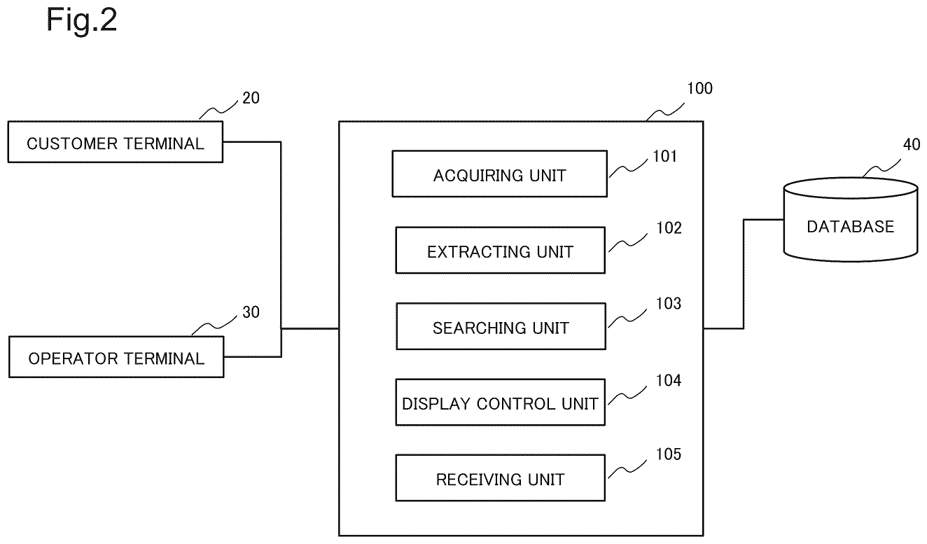

FIG. 2 is a block diagram illustrating an example of a configuration of the assistance system 100 according to the first example embodiment. The assistance system 100 according to the first example embodiment includes an acquiring unit 101, an extracting unit 102, a searching unit 103, and a display control unit 104. The assistance system 100 may include a receiving unit 105 as necessary.

In one example embodiment, the assistance system 100 is communicably connected to a customer terminal 20, an operator terminal 30, and a database 40. The customer terminal 20 is a terminal used by the customer for a conversation with an operator. The operator terminal 30 is a terminal used by the operator for a conversation with a customer. In the database 40, information regarding a store clerk who works at one or more stores is stored in association with an identifier for identifying the store clerk. In this case, the database 40 stores information regarding stores in a range where the operator receives an inquiry about a service provided or a product sold.

Each of the customer terminal 20 and the operator terminal 30 is, for example, a phone, a smartphone, a personal computer, or the like. Each of the customer terminal 20 and the operator terminal 30 includes at least one of input means such as a microphone, a button, and a keyboard. Each of the customer terminal 20 and the operator terminal 30 includes at least one of output means such as a display and a speaker. The customer and the operator have a conversation using the input means and the output means. Which input means and output means are provided can be designed as necessary.

A case where the display of the customer terminal 20 or the display of the operator terminal 30 outputs information for assisting in identifying a store clerk in accordance with control by the assistance system 100 will be described later. The information for assisting in identifying the store clerk includes information regarding the searched store clerk and information for prompting an additional utterance regarding a characteristic of the store clerk.

The information regarding the store clerk stored in the database 40 will be described. The information regarding the store clerk includes, for example, a characteristic of the store clerk. The information regarding the store clerk may include a store name of a store where the store clerk works.

The characteristic of the store clerk includes at least a characteristic that can be grasped by the customer who visited the store. The characteristic of the store clerk relates to, for example, the appearance of the store clerk or the name of the store clerk. The appearance includes the height, hairstyle, gender, age, and color of skin, eyes, or hair. The name of the store clerk is a name displayed on a name tag or the like of the store clerk. The characteristic of the store clerk may be a role of the store clerk in the store. The role of the store clerk includes, for example, a store manager, an employee, a part-timer, a person in charge of service, a person in charge of kitchen, or the like. When uniforms of store clerks are different depending on the roles of the store clerks, a characteristic of the store may include the type of the uniform of the store clerk. In the following description, a characteristic of a store clerk is managed for each store clerk based on a store clerk identifier for identifying the store clerk or a name of the store clerk.

For example, the database 40 stores a keyword indicating the characteristic of the store clerk as the characteristic of the store clerk. The keyword may be registered manually. Alternatively, the registered keyword may indicate the characteristic of the store clerk recognized using an image recognition technology from a captured image of the store clerk. A method for registering the keyword is not particularly limited.

The captured image of the store clerk may be an image of the face or upper body of the store clerk captured from the front. Such an image may be registered by the store clerk for each work shift or in each certain period of time at the store. Alternatively, the captured image of the store clerk may be an image of the store clerk captured by a monitoring camera in the store.

The database 40 may store an image from which the characteristic of the store clerk can be identified. That is, in the database 40, an image from which the characteristic of the store clerk can be identified may be stored as one piece of the information regarding the store clerk in association with the identifier of the store clerk. The database 40 may store in advance an image of the face or upper body of the store clerk captured from the front. Alternatively, the database 40 may store an image of the store clerk at work captured by the monitoring camera in the store. The database 40 stores an image of each store clerk at work captured by the monitoring camera at regular time intervals. An image of each store clerk at work may be captured by a camera other than the monitoring camera. In the captured image of the store clerk, a keyword indicating the characteristic of the store clerk may be stored in association as a characteristic label. For example, an image from which the characteristic of the store clerk can be identified, such as an image of each store clerk at work captured by the monitoring camera, may be used for search in a state of not being associated with the identifier of the store clerk.

In a case where an image captured by the monitoring camera is used, a person is detected from the image by an image recognition technology. Then, it is determined whether the detected person is a store clerk or a customer. For example, a person wearing a shop uniform is determined to be a store clerk. Alternatively, a person in a predetermined area such as the inside of a cash register counter is determined to be a store clerk. A characteristic of a store clerk is extracted from an image for a person determined to be a store clerk. The detection of the person, the determination of the store clerk, and the extraction of the characteristic of the store clerk may be performed in a device connected to the monitoring camera. Then, the database 40 stores the characteristic label indicating the characteristic extracted from the image in association with the image. When a face image of the store clerk is registered in advance, the individual store clerk can be recognized from an image of the monitoring camera. Accordingly, a characteristic label indicating the name of the store clerk may be associated with the image. When the same store clerk is detected many times, a representative image may be stored for each store clerk.

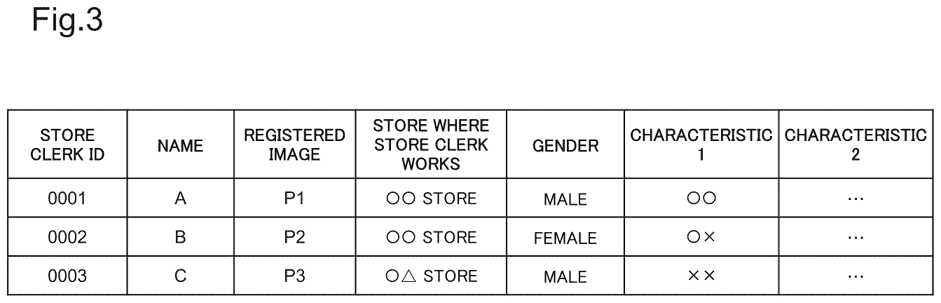

FIG. 3 is an example of information regarding the store clerk stored in the database 40. In the example illustrated in FIG. 3, the database 40 stores the name of the store clerk, an image of the store clerk, a store where the store clerk works, a gender of the store clerk, and other characteristics of the store clerk in association with a store clerk ID (identifier) which is an identifier of the store clerk. In this example, two characteristics 1 and 2 are stored as characteristics of the store clerk, but the number of characteristics stored in the database 40 is not particularly limited for each store clerk.

The acquiring unit 101 of the assistance system 100 acquires conversation data of a conversation between a customer and an operator. The acquiring unit 101 acquires the conversation data from the customer terminal 20 and the operator terminal 30. The conversation data is, for example, a result of voice recognition of voice data of a call. The conversation data may be text data as a result of voice recognition. Alternatively, the conversation data may be text data of text transmitted and received between the customer terminal 20 and the operator terminal 30.

The extracting unit 102 of the assistance system 100 extracts a characteristic of a store clerk who is a topic of the conversation from the conversation data. The extracting unit 102 performs sentence analysis on the conversation data, and extracts a keyword indicating the characteristic of the store clerk or a sentence including the characteristic of the store clerk. The extracting unit 102 may extract a keyword estimated to be a keyword related to a person as the characteristic of the store clerk. For example, the extracting unit 102 extracts a keyword that seems to be a name of a person or an appearance of a person. Alternatively, the extracting unit 102 may determine whether the conversation relates to the characteristic of the store clerk, and extract a keyword related to a person.

The searching unit 103 searches for a store clerk having a characteristic corresponding to the characteristic of the store clerk extracted by the extracting unit 102 from among store clerks who work at a store. Searching for a store clerk having a characteristic corresponding to the extracted characteristic of the store clerk includes searching for a store clerk having a characteristic that matches the extracted characteristic of the store clerk. The number of characteristics of the store clerk that the searching unit 103 refers to for the search is not particularly limited, and the characteristic extracted by the extracting unit 102 may be appropriately referred to. For example, as a search for a store clerk, the searching unit 103 refers to information regarding each store clerk stored in the database 40, and identifies an identifier of a store clerk having a characteristic matching the characteristic of the store clerk extracted by the extracting unit 102. The number of store clerks to be searched is not particularly limited, and one store clerk may be searched or a plurality of store clerks may be searched.

For example, the searching unit 103 searches for a store clerk having a characteristic matching the extracted characteristic of the store clerk using the extracted keyword as a query. For example, in a case where a keyword “female” is extracted from the conversation data, the searching unit 103 searches for information regarding a female store clerk. The searching unit 103 may search for a store clerk having a characteristic corresponding to the extracted characteristic with reference to a predetermined keyword correspondence. For example, a keyword such as “height is equal to or more than 170 cm” is defined as a keyword such as “tall”. On the other hand, in a case where the keyword “tall” is extracted, the searching unit 103 searches for information regarding a store clerk having a height equal to or more than 170 cm.

The searching unit 103 may search for the store clerk by using an image of the store clerk that is stored in the database 40 and from which the characteristic of the store clerk can be identified. As an example, the searching unit 103 uses the extracted keyword as a query, and detects an image whose characteristic label associated with the image matches the query. Then, the searching unit 103 searches for the store clerk by identifying the identifier of the store clerk associated with the image. The specific processing when the searching unit 103 uses the image in the search of the store clerk is not limited to this example.

The display control unit 104 causes a display device to display information regarding the searched store clerk. For example, the display control unit 104 displays the information regarding the store clerk stored in the database 40 for the store clerk searched by the searching unit 103. The display control unit 104 may display the name of the store clerk, the identifier of the store clerk, the image of the store clerk, the characteristic of the store clerk, or the store name of the store where the store clerk works as the information regarding the store clerk.

For example, the display control unit 104 displays the information regarding the store clerk while the customer and the operator are having a conversation. The display control unit 104 may display information on each of a plurality of searched store clerks. The display control unit 104 may display information of a store clerk who is more likely to be a store clerk that is a topic differently from information of other store clerks. For example, a store clerk having all extracted characteristics is more likely to be a store clerk on the topic than a store clerk who satisfies only some of the extracted characteristics.

The display control unit 104 causes, for example, a display device used by the operator to display the information regarding the store clerk. The display of the operator terminal 30 is an example of the display device used by the operator.

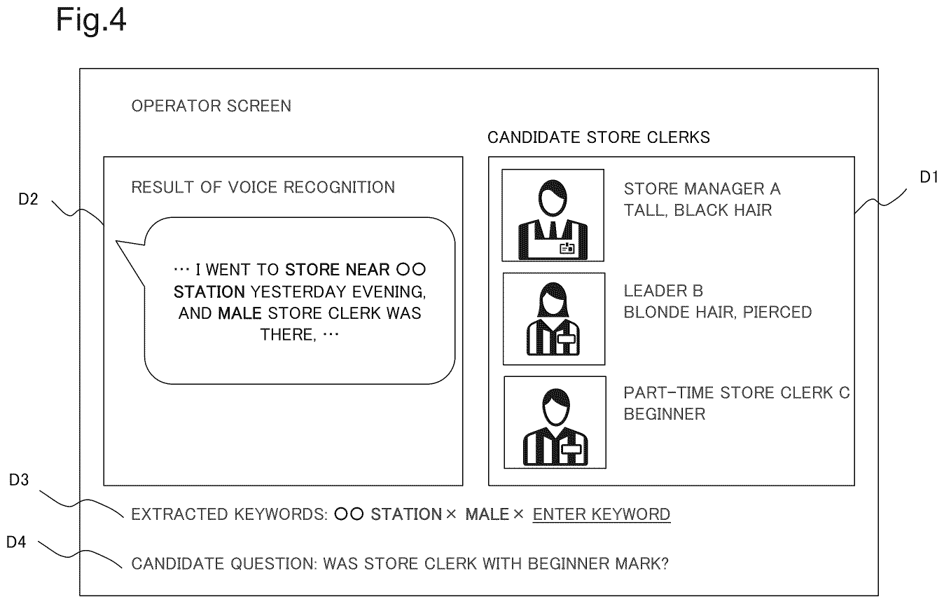

FIG. 4 is a diagram illustrating an example of an operator screen displayed by the display control unit 104 on the display device used by the operator. The operator screen displays the information regarding the searched store clerk in a region D1. In the region D1, three store clerks having characteristics extracted from the conversation data are displayed as candidates for the store clerk who is the topic.

Since the display control unit 104 causes the operator to display the information regarding the store clerk, the operator can easily ask a question for identifying which store clerk is the topic. For example, the operator can view a displayed characteristic of the store clerk and ask the customer about a characteristic other than an uttered characteristic. Therefore, even in a case where a characteristic of the store clerk spoken by the customer is ambiguous, the operator can ask the customer for an additional characteristic, and it is easy for the operator to identify the store clerk that is the topic.

The display control unit 104 may cause a display device used by the customer to display information regarding the store clerk, instead of the display device used by the operator. The display of the customer terminal 20 is an example of the display device used by the customer. For example, in a case where the customer and the operator are having a conversation by text, for example, by chatting, the display control unit 104 may display the information regarding the store clerk on a chatting screen of the customer terminal 20. The display control unit 104 causes the customer to display the information regarding the store clerk, and thus the customer can easily explain the additional characteristic of the store clerk. Therefore, the assistance system 100 makes it easy for the operator to identify the store clerk who is the topic.

Similarly to the customer terminal 20, the display control unit 104 may also cause the display of the operator terminal 30 to display the information regarding the store clerk. As a result, the operator can confirm the same information as that confirmed by the customer. Then, the operator can appropriately respond to the contents spoken by the customer based on the displayed information viewed by the customer.

The display control unit 104 may display information for assisting in identifying the store clerk in addition to the information regarding the searched store clerk. The operator screen illustrated in FIG. 4 includes a region D2 for displaying conversation data. The region D2 displays a result of voice recognition of voice data of the call as the conversation data. The operator screen illustrated in FIG. 4 includes a region D3 in which a keyword extracted from the conversation data is displayed. The region D3 displays a keyword “male” extracted from the conversation data as a characteristic of the store clerk.

The display control unit 104 may cause the display device to display information prompting an additional utterance regarding a characteristic of the store clerk. The information prompting the additional utterance is, for example, information indicating that the number of search results of the store clerk having the characteristic corresponding to the extracted characteristic is larger than a predetermined number. The display control unit 104 causes the display device to display a message such as “There are too many candidates for the store clerk”. With such a display, the operator or the customer can grasp that the characteristic for identifying the store clerk is insufficient.

The display control unit 104 may cause a question regarding the characteristic of the store clerk to be displayed as the information prompting the additional utterance. The operator screen illustrated in FIG. 4 includes a region D4 for displaying a question about a characteristic of the store clerk. The operator may read out the displayed question to ask the customer on the phone for an answer. Alternatively, when the question is displayed to the customer, the customer may view the question and enter an answer. For example, the display control unit 104 displays a question regarding a characteristic that has not yet been extracted from the conversation data in order to prompt utterance. The display control unit 104 may display a question prompting utterance regarding the characteristics of some of the plurality of searched store clerks. For example, in a case where three store clerks are searched based on the conversation so far, a question as to whether a store clerk who is the topic has a characteristic of one of the three store clerks may be displayed.

The receiving unit 105 receives information input using input means such as a button or a keyboard provided in the customer terminal 20 or the operator terminal 30. For example, the receiving unit 105 may receive an input of a characteristic of the store clerk from the operator or the customer. Then, the searching unit 103 may search for the store clerk based on the characteristic of the store clerk received by the receiving unit 105 in addition to the characteristic of the store clerk extracted from the conversation data. This makes it possible to perform a search with a specific characteristic rather than an ambiguous characteristic uttered by the customer, or a search with a characteristic that has failed to be extracted by the system from the conversation.

The receiving unit 105 may receive an operation indicating that the store clerk has been identified. The operation indicating that the store clerk has been identified is an operation of selecting the store clerk displayed on the display device, an operation of ending the search for the store clerk by pressing an end button displayed on the display device, or the like.

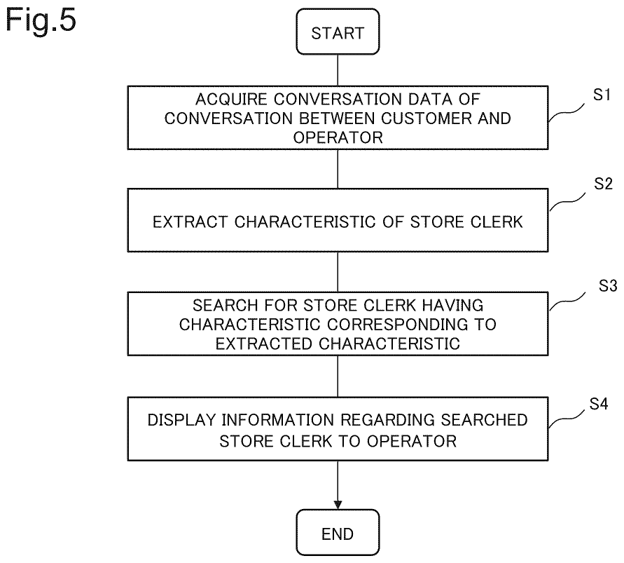

FIG. 5 is a flowchart illustrating an example of an operation of the assistance system 100 according to the first example embodiment. The following operation is an example and can be variously changed. The assistance system 100 starts the operation illustrated in FIG. 5, for example, in response to an operator receiving a phone call from a customer. The assistance system 100 may start the operation illustrated in FIG. 5 in response to the start of a chat between the customer and the operator.

The acquiring unit 101 acquires conversation data of a conversation between the customer and the operator (step S1). The extracting unit 102 extracts a characteristic of a store clerk from the conversation data regarding the store clerk who is a topic of the conversation (step S2).

The searching unit 103 searches for a store clerk having a characteristic corresponding to the extracted characteristic of the store clerk from among store clerks who work at a store (step S3).

The display control means causes the display device to display information regarding the searched store clerk (step S4). Thus, the assistance system 100 ends the operation illustrated in FIG. 5.

The assistance system 100 may repeat the processing in steps S1 to S4 until the conversation between the customer and the operator ends. For example, while the conversation between the customer and the operator continues, the assistance system 100 acquires the conversation data in step S1 and extracts a characteristic of a store clerk in step S2. Then, in a case where a new characteristic of a store clerk is extracted in step S2, the searching unit 103 searches for the store clerk based on a plurality of characteristics including the additional characteristic of the store clerk in step S3. In step S4, the display control unit 104 displays information regarding the store clerk for the store clerk searched based on the plurality of characteristics.

Even in a case where the conversation between the customer and the operator continues, it is assumed that the processing by the assistance system 100 may be stopped when the store clerk who is the topic of the conversation is identified. Therefore, when the receiving unit 105 receives an operation indicating that the store clerk has been identified, the assistance system 100 may end the operation. A determining unit (not illustrated) of the assistance system 100 may determine that the store clerk has been identified and end the operation. For example, the extracting unit 102 extracts the name of the store clerk from the content of utterance by the operator. Thereafter, in a case where the extracting unit 102 extracts an utterance that the customer agrees with from the content of utterance by the customer, the determining unit determines that the store clerk has been identified. Alternatively, the determining unit of the assistance system 100 may determine that the store clerk has been identified in a case where no additional utterance regarding the characteristic of the store clerk is extracted.

In a case where a store clerk having a characteristic corresponding to the characteristic extracted from the conversation data is not stored in the database, the assistance system 100 may end the operation after step S3. The assistance system 100 may end the operation after repeating steps S1 to S4 an arbitrary number of times.

What a customer talks to an operator may be ambiguous. It is difficult for the operator to identify a topic of conversation from such an ambiguous content. According to the first example embodiment, the acquiring unit 101 acquires the conversation data of the conversation between the customer and the operator. The extracting unit 102 extracts, from the conversation data, the characteristic of the store clerk who is the topic of the conversation. Then, the searching unit 103 searches for a store clerk having a characteristic corresponding to the extracted characteristic of the store clerk from among the store clerks who work at the store, and the display control unit 104 causes the display device to display information regarding the searched store clerk.

Therefore, when the information regarding the store clerk is displayed to the operator, the operator can check with the customer about the store clerk who is the topic by viewing the displayed information. When the store clerk who is the topic during the conversation with the customer can be checked with the customer, it is possible to reduce labor for the operator or the manager of the store to identify the store clerk after serving the customer. For example, in a case where the manager of the store conducts a hearing survey of the store clerk based on information obtained by the operator from the customer, the survey can be simplified. Therefore, it is easy to identify the store clerk who is the topic of the conversation from the ambiguous information provided by the customer.

In a case where the information regarding the store clerk is displayed to the customer, the customer remembers the store clerk who has appeared in the store by viewing the displayed information. Then, the customer can then provide an additional characteristic to the operator. Therefore, it is easy for the operator and the customer to identify a store clerk who is a conversation topic from ambiguous information provided by the customer.

### Second Example Embodiment

In a second example embodiment, an assistance system 100 that assists in identifying a store clerk based on not only a characteristic of the store clerk provided in a conversation but also other information will be described. Regarding configurations in the second example embodiment, description of the same configurations as those described in the first example embodiment will be omitted.

As described above, in the assistance system 100, a searching unit 103 may search for a plurality of store clerks. In order to more quickly search for a store clerk who is a topic of a conversation, it is assumed that store clerks searched by the searching unit 103 are preferably narrowed down in many cases. Therefore, in the present example embodiment, as an example, processing for narrowing down store clerks to be searched by the searching unit 103 is performed.

For example, when a store visit date and time when a customer visited a store is known, it is considered that store clerks to be searched by the searching unit 103 can be narrowed down to a store clerk who worked at the store visit date and time. Therefore, an extracting unit 102 may extract, from conversation data acquired by an acquiring unit 101, the store visit date and time when the customer visited the store. For example, the extracting unit 102 extracts a keyword that can be related to the date and time. The extracting unit 102 may determine whether the conversation is about the customer's store visit date and time and extract a keyword about the date and time.

Then, the searching unit 103 may search for the store clerk based on the store visit date and time and a work shift at the store. For example, the searching unit 103 refers to the work shift and searches for a store clerk having a characteristic corresponding to the extracted characteristic from among store clerks who worked at the store on the date and time corresponding to the store visit date and time. As a result, it is possible to narrow down searched store clerks to a store clerk who is likely to have actually served the customer.

The work shift is stored in a database 40, for example. However, the work shift may be stored in a database different from the database that stores information regarding store clerks, and is not particularly limited.

The memory of the customer may be ambiguous, and the store visit date and time extracted by the extracting unit 102 may be different from the actual store visit date and time when the customer visited the store. Therefore, the searching unit 103 may search for the store clerk based on store visit dates and times and work shifts of the store before and after the extracted store visit date and time. The store visit dates and times before and after the extracted store visit date and time may be appropriately determined as, such as time zones before and after the same day as the extracted store visit date and time, or the same time on days different from the extracted store visit date and time. In a case where the extracted store visit date and time is not uniquely determined, such as when the customer utters a plurality of candidates for the store visit date and time or utters a time zone of the store visit date and time, the searching unit 103 may search for the store clerk based on each candidate for the store visit date and time and the time zone and the work shift at the store.

As described in the first example embodiment, there is a case where a captured image of a store clerk at work is stored in the database 40. Then, the searching unit 103 may search for the store clerk using the image. Also in this case, store clerks to be searched may be narrowed down according to the date and time when the customer visited the store. That is, the searching unit 103 may search for the store clerk based on the extracted store visit date and time and the image capturing date and time when the image of the store clerk was captured. That is, the searching unit 103 searches for the store clerk using the image captured within a predetermined time from the store visit date and time extracted from the conversation data. This also makes it possible to narrow down searched store clerks to a store clerk who is likely to have actually served the customer.

Then, the searching unit 103 may search for the store clerk based on the image capturing date and time when the image of the store clerk was captured, and the work shift at the store. For example, the searching unit 103 detects a captured image of the store clerk having a characteristic corresponding to the characteristic of the store clerk extracted by the extracting unit 102 from images of store clerks. In this case, the searching unit 103 acquires an image capturing date and time when the detected image was captured. Then, the searching unit 103 refers to the work shift and searches for the store clerk who worked at the acquired image capturing date and time or before and after the acquired image capturing date and time. In a case where an image from which a characteristic of the store clerk can be identified is not associated with the identifier of the store clerk, searching for the store clerk in this manner makes it possible to quickly search for the store clerk.

It is conceivable to narrow down store clerks to be searched depending on the characteristics of the store where the customer visited. The extracting unit 102 extracts characteristics of the store from the conversation data. The characteristics of the store include at least a characteristic that can be grasped by the customer. The characteristics of the store include, for example, the name of the store, the address of the store, a name of a facility near the store, a name of a street or an intersection where the store faces, a name of a building where the store is located, and the like. For example, the extracting unit 102 extracts a keyword that can be related to the name of the location or a keyword that can be related to the name of the store as a characteristic of the store. The extracting unit 102 may determine whether a topic is related to the store where the customer visited, and extract a keyword related to a characteristic of the store. In this case, a characteristic of each store is stored in the database 40.

In this case, in a case where the searching unit 103 searches for a store clerk having a characteristic corresponding to an extracted characteristic of a store clerk, the searching unit 103 searches for a store clerk who works at a store having a characteristic corresponding to an extracted characteristic of the store. For example, the searching unit 103 searches for the store corresponding to the extracted characteristic. Then, the searching unit 103 searches for the store clerk having the characteristic corresponding to the extracted characteristic from store clerks who work at the searched store.

Characteristics of a store provided by a customer may be ambiguous and uncertain. Therefore, the searching unit 103 may also search for characteristics with similar pronunciation or characteristics that are easily misunderstood. In a case where there is a plurality of stores near the store actually used by the customer, the customer may wrongly utter a characteristic of a store in the vicinity of the store actually used by the customer. Therefore, the searching unit 103 may expand a search target for the store clerk to stores in the vicinity of the store having the characteristic corresponding to the extracted characteristic of the store. The searching unit 103 searches for the store having the characteristic corresponding to the extracted characteristic of the store and searches for a store near the store. Then, in a case where the searching unit 103 searches for a store clerk having a characteristic corresponding to the extracted characteristic of the store clerk, the searching unit 103 searches for a store clerk who works at the nearby store.

The extracting unit 102 may extract characteristics of a product purchased by the customer from the conversation data. The characteristics of the product include, for example, the name of the product, a product code, the type of the product, and the like.

In a case where the characteristics of the product are extracted from the conversation data, the searching unit 103 may refer to the sales record of the product and search for a store clerk who is a topic. For example, the searching unit 103 may search for a store clerk who worked at a date and time when the product that is a topic was sold, based on the sales record of the product and a work shift. Alternatively, the searching unit 103 may search for a store clerk whose image was captured at the date and time when the product was sold or before or after the date and time, based on the sales record of the product and the image capturing date and time when the image of the store clerk was captured.

According to the second example embodiment, similarly to the first example embodiment, it is easy for an operator to identify a store clerk who is a conversation topic from an ambiguous content spoken by a customer. According to the second example embodiment, the searching unit 103 searches for a store clerk based on not only characteristics of a store clerk extracted from conversation data but also other information. For example, the searching unit 103 searches for a store clerk based on a date and time when a customer visited a store, a work shift at the store, or an image capturing date and time when an image of the store clerk was captured. Therefore, the assistance system 100 can further narrow down candidates for a store clerk who is a topic, as compared with a case where a store clerk is searched only based on a characteristic of the store clerk.

### Third Example Embodiment

In a conversation between a customer and an operator, a store used by the customer may become a topic. As a third example embodiment, an assistance system 100 that assists in identifying a store that is a conversation topic will be described. An assistance system 100 according to the third example embodiment is different from the assistance system 100 according to the first example embodiment in that the assistance system 100 according to the third example embodiment assists in identifying a store instead of assisting in identifying a store clerk. Description of configurations similar to those described in the first example embodiment will be partially omitted.

A block diagram of a configuration of the assistance system 100 according to the third example embodiment is similar to that illustrated in FIG. 2 in the first example embodiment. As in the first example embodiment, the assistance system 100 according to the third example embodiment includes an acquiring unit 101, an extracting unit 102, a searching unit 103, and a display control unit 104, and includes a receiving unit 105 as necessary.

In the third example embodiment, the assistance system 100 is communicably connected to a customer terminal 20, an operator terminal 30, and a database 40. Configurations of the customer terminal 20 and the operator terminal 30 are similar to those described in the first example embodiment. In the third example embodiment, the database 40 is a database that stores information regarding a plurality of stores.

The information regarding the stores stored in the database 40 includes characteristics of the stores. The characteristics of the stores include, for example, the names of the stores, the addresses of the stores, names of facilities near the stores, names of streets or intersections where the stores face, names of buildings where the stores are located, and the like.

The database 40 may store the opening hours of the stores, contact information of the stores, and the positions of the stores on a map as the information regarding the stores.

Similarly to the first example embodiment, the acquiring unit 101 according to the third example embodiment acquires conversation data of a conversation between a customer and an operator.

The extracting unit 102 according to the third example embodiment extracts a characteristic of a store from the conversation data. A method of extracting the characteristic of the store is similar to the method described for the extracting unit 102 according to the second example embodiment.

The searching unit 103 searches for a store having a characteristic corresponding to the characteristic of the store extracted by the extracting unit 102. For example, the searching unit 103 searches for information regarding the store including at least one of the name of the store, the identifier of the store, and the position of the store stored in the database 40.

The display control unit 104 causes a display device to display the information regarding the searched store. For example, the display control unit 104 causes the display device to display the information regarding the store stored in the database 40 for the store searched by the searching unit 103.

As in the first example embodiment, the display control unit 104 may display the information regarding the store while the customer and the operator are having a conversation. The display control unit 104 may cause either or both of displays of the customer terminal 20 and the operator terminal 30 to display the information regarding the store.

The extracting unit 102 may extract a store visit date and time when the customer visited the store, similarly to the second example embodiment. Then, the searching unit 103 may narrow down stores open at the extracted store visit date and time, based on the extracted store visit date and time. The searching unit 103 refers to the database 40 and searches for a store having a characteristic corresponding to the characteristic extracted from the conversation data among the stores open.

For example, the receiving unit 105 may receive an input of a characteristic of the store from the operator or the customer. The receiving unit 105 may receive an operation indicating that the store has been identified. The operation indicating that the store has been identified is an operation of selecting the store displayed on the display device, an operation of ending the search for the store by pressing an end button displayed on the display device, or the like.

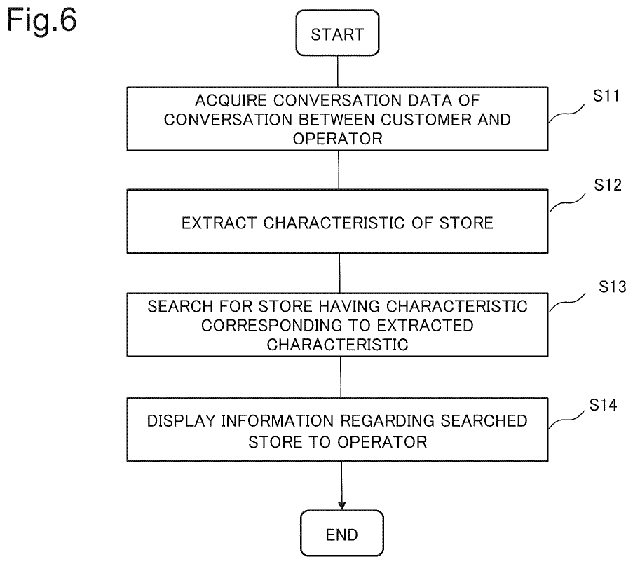

FIG. 6 is a flowchart illustrating an example of an operation of the assistance system 100 according to the third example embodiment. The assistance system 100 starts the operation illustrated in FIG. 6, for example, in response to an operator receiving a phone call from a customer. The assistance system 100 may start the operation illustrated in FIG. 6 in response to the start of a chat between the customer and the operator.

The acquiring unit 101 acquires conversation data of a conversation between the customer and the operator (step S11). The extracting unit 102 extracts a characteristic of a store from the conversation data for the store that is a topic of the conversation (step S12).

The searching unit 103 refers to the database 40 and searches for a store having a characteristic corresponding to the extracted characteristic of the store (step S13).

The display control means causes the display device to display information regarding the searched store (step S14). Thus, the assistance system 100 ends the operation illustrated in FIG. 6.

According to the third example embodiment, the acquiring unit 101 acquires the conversation data of the conversation between the customer and the operator. The extracting unit 102 extracts, from the conversation data, the characteristic of the store that is the topic of the conversation. Then, the searching unit 103 searches for a store having a characteristic corresponding to the extracted characteristic of the store, and the display control unit 104 displays information regarding the searched store on the display device.

Therefore, by viewing the information regarding the store, the customer or the operator can easily take an additional action to identify the store. Therefore, it is easy to identify the store that is the topic of the conversation from ambiguous information provided by the customer.

### Modifications

The above example embodiments may be modified and used. Modifications will be described below.

In each of the above example embodiments, the case where the operator of the customer center responds to an inquiry from the customer has been described. However, the present disclosure is also applicable to a case where a store clerk of each store responds to an inquiry from a customer instead of the operator. In the present modification, the operator terminal 30 is a terminal used by a store clerk. In this case, the assistance system 100 may be arranged in each store instead of the customer center. The assistance system 100 assists in identifying a store clerk who is a topic among store clerks who work at each store.

Alternatively, the assistance system 100 may assist in identifying a store that is a topic. For example, it is assumed that a customer mistakenly calls a store for an inquiry about another store. In this case, a store clerk identifies the other store that is the topic, based on information regarding the store displayed by the display control unit 104. Then, the store clerk can guide information of the other store to the customer.

In the above example embodiments, the case where the acquiring unit 101 acquires the conversation data from the customer terminal 20 and the operator terminal is described. However, the acquiring unit 101 may acquire the conversation data from another device that acquires the conversation data between the customer terminal 20 and the operator terminal 30. In this case, the assistance system 100 is communicably connected to the other device. The assistance system 100 may be communicably connected to the customer terminal 20 and the operator terminal 30 as necessary.

In the above example embodiment, the case where the display control unit 104 displays the information regarding the store clerk while the operator and the customer are having a conversation is described. However, the display control unit 104 may display the information regarding the store clerk or store searched by the searching unit 103 after the conversation between the customer and the operator ends. The display control unit 104 causes the operator to display information regarding the store clerk or the store after the conversation ends, and thus the operator can easily record the store clerk or the store that was the topic in the report reporting the content of the conversation.

In the above example embodiments, the case where the display control unit 104 displays the information regarding the store clerk on the display device used by the operator or the customer is described. However, the display control unit 104 may cause a terminal used by the manager of the store or by the manager of the customer center to display information regarding the store clerk or the store searched by the searching unit 103. The manager of the store or the manager of the customer center can refer to the information regarding the store clerk, identify the store clerk, and propose a measure for improving the store.

### Hardware Configuration

In each of the above-described example embodiments, each component of the assistance system 100 represents a block in units of the functions. Some or all of the components of the assistance system 100 may be implemented by an arbitrary combination of a computer 500 and a program.

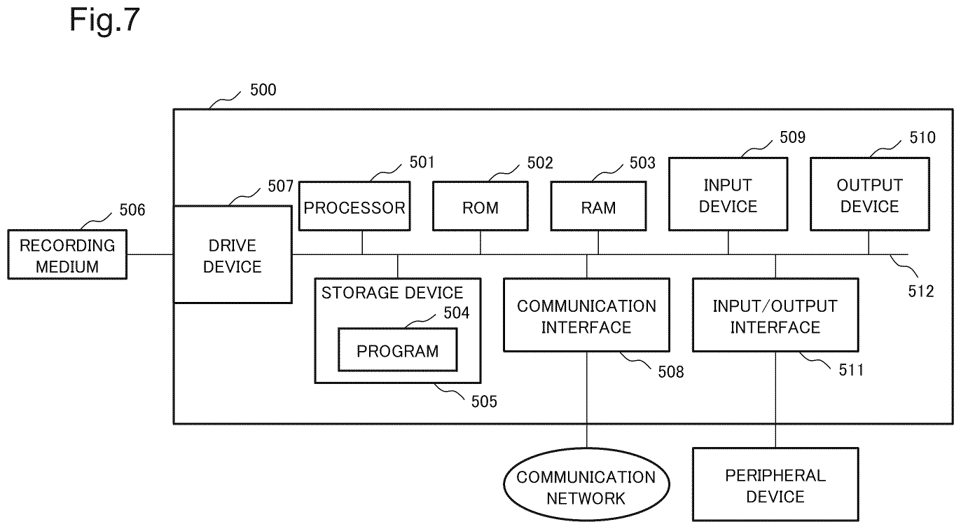

FIG. 7 is a block diagram illustrating an example of a hardware configuration of the computer 500. Referring to FIG. 7, the computer 500 includes, for example, a processor 501, a read-only memory (ROM) 502, a random-access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for implementing each function of the assistance system 100. The program 504 is stored in advance in the ROM 502, the RAM 503, and the storage device 505. The processor 501 implements each of the functions of the assistance system 100 by executing instructions included in the program 504. For example, the processor 501 of the assistance system 100 executes the instructions included in the program 504 to implement the functions of the assistance system 100. The RAM 503 may store data to be processed by each of the functions of the assistance system 100.

The drive device 507 reads and writes data from and to the recording medium 506. The communication interface 508 provides an interface with a communication network. The input device 509 is, for example, a mouse, a keyboard, a microphone, or the like, and receives an input of information from a user or the like. The output device 510 is, for example, a display, and outputs (displays) information to the user or the like. The input/output interface 511 provides an interface with a peripheral device. The bus 512 connects the components of the hardware. The program 504 may be supplied to the processor 501 via a communication network, or may be stored in the recording medium 506 in advance, read by the drive device 507, and supplied to the processor 501.

The hardware configuration illustrated in FIG. 7 is an example, and other components may be added or some components may not be included.

There are various modifications in a method of implementing the assistance system 100. For example, the assistance system 100 may be implemented by an arbitrary combination of computers and programs that are different for each component. A plurality of components included in the assistance system 100 may be implemented by an arbitrary combination of one computer and a program.

At least a part of the assistance system 100 may be provided in a software as a service (SaaS) format. That is, at least one of the functions for implementing the assistance system 100 may be executed by software executed via a network.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments can be described as the following supplementary notes, but are not limited to the following.

### Supplementary Note 1

An assistance system including
acquiring means configured to acquire conversation data of a conversation between a customer and an operator,
extracting means configured to extract, from the conversation data, a characteristic of a store clerk who is a topic of the conversation,
searching means configured to search for the store clerk having a characteristic corresponding to the extracted characteristic of the store clerk from among store clerks who work at a store, and
display control means configured to cause a display device to display information regarding the searched store clerk.

### Supplementary Note 2

The assistance system described in Supplementary note 1, in which
the extracting means extracts, from the conversation data, a store visit date and time when the customer visited the store, and
the searching means searches for the store clerk based on the store visit date and time and a work shift at the store.

### Supplementary Note 3

The assistance system described in Supplementary note 1 or 2, in which
the searching means searches for the store clerk using an image of the store clerk from which the characteristic of the store clerk can be identified.

### Supplementary Note 4

The assistance system described in Supplementary note 3, in which
the searching means searches for the store clerk by detecting the image including the characteristic corresponding to the extracted characteristic of the store clerk.

### Supplementary Note 5

The assistance system described in Supplementary note 3 or 4, in which
the searching means searches for the store clerk based on an image capturing date and time when the image was captured and a work shift at the store.

### Supplementary Note 6

The assistance system described in any one of Supplementary notes 3 to 5, in which
the extracting means extracts, from the conversation data, a store visit date and time when the customer visited the store, and
the searching means searches for the store clerk based on the extracted store visit date and time and an image capturing date and time when the image was captured.

### Supplementary Note 7

The assistance system according to any one of Supplementary notes 1 to 6, in which
the extracting means extracts, from the conversation data, a characteristic of a store where the customer visited, and
the searching means searches for the store clerk from among store clerks who work at a store having a characteristic corresponding to the extracted characteristic of the store.

### Supplementary Note 8

The assistance system according to any one of Supplementary notes 1 to 7, in which
the searching means searches for the store clerk from among store clerks who work at a store near a store having a characteristic corresponding to an extracted characteristic of a store.

### SUPPLEMENTARY NOTE 9

The assistance system according to any one of supplementary notes 1 to 8, in which
the display control means causes the display device to display information prompting an additional utterance regarding a characteristic of the store clerk.

### Supplementary Note 10

An assistance method including
acquiring conversation data of a conversation between a customer and an operator,
extracting, from the conversation data, a characteristic of a store clerk who is a topic of the conversation,
searching for a store clerk having a characteristic corresponding to the extracted characteristic of the store clerk from among store clerks who work at a store, and
causing a display device to display information regarding the searched store clerk.

### Supplementary Note 11

A program causes a computer to execute processing of
acquiring conversation data of a conversation between a customer and an operator,
extracting, from the conversation data, a characteristic of a store clerk who is a topic of the conversation,
searching for a store clerk having a characteristic corresponding to the extracted characteristic of the store clerk from among store clerks who work at a store, and
causing a display device to display information regarding the searched store clerk.

### Supplementary Note 12

An assistance system including
acquiring means configured to acquire conversation data of a conversation between a customer and an operator,
extracting means configured to extract, from the conversation data, a characteristic of a store that is a topic of the conversation,
searching means configured to search for the store having a characteristic corresponding to the extracted characteristic of the store, and
display control means configured to cause a display device to display information regarding the searched store.

What is claimed is:

1. An assistance system comprising:
a memory storing instructions; and
one or more processors configured to execute the instructions to:
acquire conversation data of a conversation between a customer and an operator;
extract, from the conversation data, a characteristic of a store clerk who is a topic of the conversation;
search for a store clerk having a characteristic corresponding to the extracted characteristic of the store clerk from among store clerks who work at a store; and
cause a display device to display information regarding the searched store clerk.

2. The assistance system according to claim 1, wherein
the one or more processors are further configured to execute the instructions to:
extract, from the conversation data, a store visit date and time when the customer visited the store; and
search for the store clerk based on the store visit date and time and a work shift at the store.

3. The assistance system according to claim 1, wherein
the one or more processors are further configured to execute the instructions to:
search for the store clerk by using an image of the store clerk from which the characteristic of the store clerk can be identified.

4. The assistance system according to claim 3, wherein
the one or more processors are further configured to execute the instructions to:
search for the store clerk by detecting the image including the characteristic corresponding to the extracted characteristic of the store clerk.

5. The assistance system according to claim 3, wherein
the one or more processors are further configured to execute the instructions to:
search for the store clerk based on an image capturing date and time when the image was captured and a work shift at the store.

6. The assistance system according to claim 3, wherein
the one or more processors are further configured to execute the instructions to:
extract, from the conversation data, a store visit date and time when the customer visited the store; and
search for the store clerk based on the extracted store visit date and time and an image capturing date and time when the image was captured.

7. The assistance system according to claim 1, wherein
the one or more processors are further configured to execute the instructions to:
extract, from the conversation data, a characteristic of a store where the customer visited; and
search for the store clerk from among store clerks who work at a store having a characteristic corresponding to the extracted characteristic of the store.

8. The assistance system according to claim 1, wherein
the one or more processors are further configured to execute the instructions to:
search for the store clerk from among store clerks who work at a store near a store having a characteristic corresponding to an extracted characteristic of a store.

9. The assistance system according to claim 1, wherein
the one or more processors are further configured to execute the instructions to:
cause the display device to display information prompting an additional utterance regarding a characteristic of the store clerk.

10. An assistance method executed by a computer, the assistance method comprising:
acquiring conversation data of a conversation between a customer and an operator;
extracting, from the conversation data, a characteristic of a store clerk who is a topic of the conversation;
searching for a store clerk having a characteristic corresponding to the extracted characteristic of the store clerk from among store clerks who work at a store; and
causing a display device to display information regarding the searched store clerk.

11. A non-transitory computer-readable recording medium that records a program for causing a computer to execute:
acquiring conversation data of a conversation between a customer and an operator;
extracting, from the conversation data, a characteristic of a store clerk who is a topic of the conversation;
searching for a store clerk having a characteristic corresponding to the extracted characteristic of the store clerk from among store clerks who work at a store; and
causing a display device to display information regarding the searched store clerk.

12. The assistance system according to claim 1, wherein
the one or more processors are further configured to execute the instructions to:
extract, from the conversation data, a characteristic of a store that is a topic of the conversation;
search for the store having a characteristic corresponding to the extracted characteristic of the store; and
cause the display device to display information regarding the searched store.
